(19) United States
(12) Patent Application Publication
(10) Pub. No.: US 2008/0007405 A1
(43) Pub. Date: Jan. 10, 2008

(54) OUTDOOR WARNING DEVICE

(75) Inventor: Po-Cho Kuo, Hsin Tien City (TW)

Correspondence Address: SEVEN STARS ELECTRONICS TAIWAN LTD., P.O. BOX 108-00403, TAIPEI, omitted

(73) Assignee: SEVEN STARS ELECTRONICS TAIWAN LTD., Hsin Tien City (TW)

(21) Appl. No.: 11/428,568

(22) Filed: Jul. 4, 2006

(51) Int. Cl. G08B 13/00

(52) U.S. Cl. 340/565

(57) ABSTRACT

An outdoor warning device is disclosed. The outdoor warning device comprises a sensor, a controller, an alarm module and a power supply. The sensor is adopted for sensing moving objects and generating a sensing signal. The controller is connected to the sensor and is adopted for receiving the sensing signal from the sensor and outputs the sensing signal. The alarm module is connected to the controller and is adopted for generating alarm to warn a user according to the sensing signal outputted by the controller. The power supply is adopted for supplying power to the sensor, the controller and the alarm module.

### BACKGROUND OF THE INVENTION

1. Field of Invention

The present invention relates to an outdoor warning device, and more particularly to an outdoor warning device, which can keep out moving objects and protect the user.

2. Description of the Related Art

Modern life demands more work and allows less free time for people to enjoy. To make good use of the limited free time, people try to enjoy the best entertainment in order to release the pressure from work. Participating in outdoor activities such as camping is one of the great ways to release pressure. Camping not only gets the family together but also provides relaxation from the busy city life. However, camping can be risky if wild animals are present in the area. Theft of personal belongings is also a concern. Thus, as fun as camping is, campers still have their worries due to the risks described above. Even though people enjoy outdoor activity, they still prefer not to stay outdoor overnight, as safety is the most important issue for people.

Furthermore, people may encounter strangers during outdoor activities, and it is difficult to avert invasion from uninvited guests, especially when important belongings are placed in the tent. One way of outdoor security is to have some weapons in the tent, but this is still not the best way.

Some security devices such as conventional detection sensors for house and car, visitor notifying devices and baby monitoring devices for home security are available. However, no security devices or detection sensors derived from the above conventional security devices are available for camping. The outdoor security device may sense approaching or moving objects and use light or alarm sound to warn the camper and keep out wild animals.

Therefore, increasing the safety of outdoor activities is an important issue for manufacturers in the field.

### SUMMARY OF THE INVENTION

According to an aspect of the present invention, the outdoor warning device comprises a sensor for sensing any approaching or moving objects, and also generates a high-frequency signal wave to keep out the moving objects to achieve protection.

According to another aspect of the present invention, the outdoor warning device comprises an alarm module for generating bright light or sound to warn the user of any approaching or moving objects.

According to another aspect of the present invention, the outdoor warning device comprises a switch that has a function to set up the alarm module to generate bright light and/or warning sound to warm the user.

According to another aspect of the present invention, the outdoor warning device comprises an alarm device to receive a sensing signal from the controller for generating bright light, sound or vibration to warn the user. Thus, the user may be notified of any approaching or moving objects located within the range of the outdoor warning device.

### BRIEF DESCRIPTION OF THE DRAWING

FIG. 1 is a block diagram of an outdoor warning device according to an embodiment of the present invention.

FIG. 2 is a flowchart illustrating a method of detecting any moving objects according to an embodiment of the present invention.

FIG. 3 is a block diagram of an outdoor warning device according to another embodiment of the present invention.

FIG. 4 is a flowchart illustrating a method of detecting any moving objects according to another embodiment of the present invention.

### DETAIL DESCRIPTION OF THE EMBODIMENTS

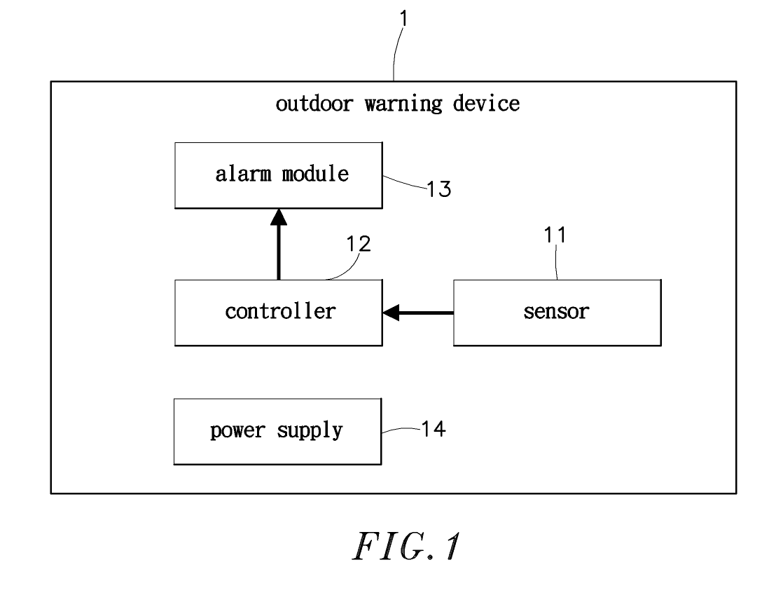

Referring to FIG. 1, an outdoor warning device 1 of the present invention comprises a sensor 11, a controller 12, an alarm module 13 and a power supply 14.

The sensor 11 can detect an approaching or moving object and generate a sensing signal.

The controller 12 is connected to the sensor 11 and can receive and transmit the sensing signal generated by the sensor 11.

The alarm module 13 is connected to the controller 12 and can receive the sensing signal transmitted from the controller 12 for warning.

The power supply 14 is adopted for supplying power to the sensor 11, the controller 12 and the alarm module 13.

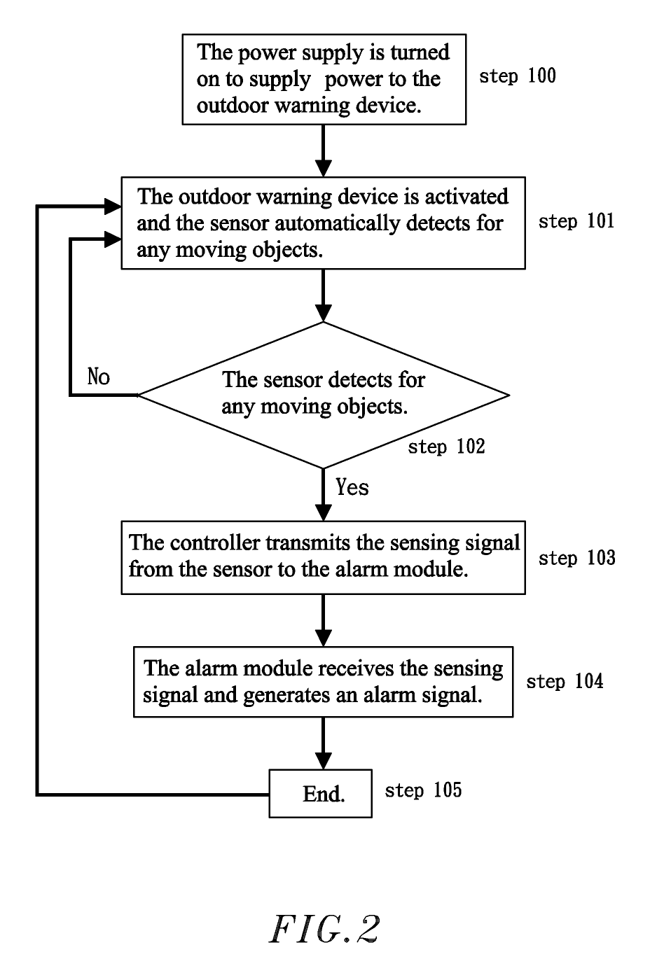

Referring to FIG. 2, a method of detecting moving objects according to an embodiment of the present invention is described hereinafter.

At step 100, the power supply 14 is turned on to supply power to the outdoor warning device 1.

At step 101, the outdoor warning device 1 is activated and the sensor 11 automatically detects for any moving objects.

At step 102, the sensor 11 detects for any moving objects, if a moving object is detected, a sensing signal is generated; otherwise the process returns back to step 101.

At step 103, the controller 12 transmits the sensing signal from the sensor 11 to the alarm module 13.

At step 104, the alarm module 13 receives the sensing signal and generates an alarm signal.

At step 105, the process ends and returns back to step 101.

While using the outdoor warning device 1, the power supply 14 of the outdoor warning device 1 supplies power to the sensor 11 to detect outside activities, and if any objects are approaching or moving within a detecting range, the sensor 11 detects the movement and generates a sensing signal. The sensing signal generated from the sensor 11 is transmitted to the alarm module 13 by the controller 12, and the alarm module 13 generates an alarm signal to warn the user.

The sensor 11 can be a radar sensor, an infrared ray sensor or an ultrasonic sensor using a signal wave to detect any approaching or moving objects. If the sensor 11 is a radar sensor, the frequency and the amplitude of the radar is used to detect the movement of the object. If the sensor 11 is an infrared ray sensor, the infrared ray is used to detect the movement of the objects. If the sensor 11 is an ultrasonic sensor, ultrasound is used to detect the movement of the objects. Moreover, the sensor 11 may also employ ultrasound to generate a high-frequency signal wave to keep out the moving objects. When a moving object approaches the outdoor warning device 1 or moves within the detecting range, the ultrasonic sensor of the sensor 11 outputs a high-frequency signal wave capable of stimulating the moving object in a manner which makes the moving object uncomfortable so that the moving object does not dare to come closer to the sensor 11.

The sensor 11 can be a radar sensor, an infrared ray sensor or an ultrasonic sensor to detect the moving objects. The sensor 11 can also be a combination of two elements selected from a group consisting of the radar sensor, the infrared ray sensor and the ultrasonic sensor. The sensor 11 can also be a combination of the radar sensor, the infrared ray sensor and the ultrasonic sensor. Thus, the user has several choices according to the actual need.

The sensor 11 can be a radar sensor, an infrared ray sensor or an ultrasonic sensor, which is only employed for detecting the movement of the objects, and it is not intended for limiting the scope of the present invention, and any equivalent device shall be also construed to be within the scope of the present invention.

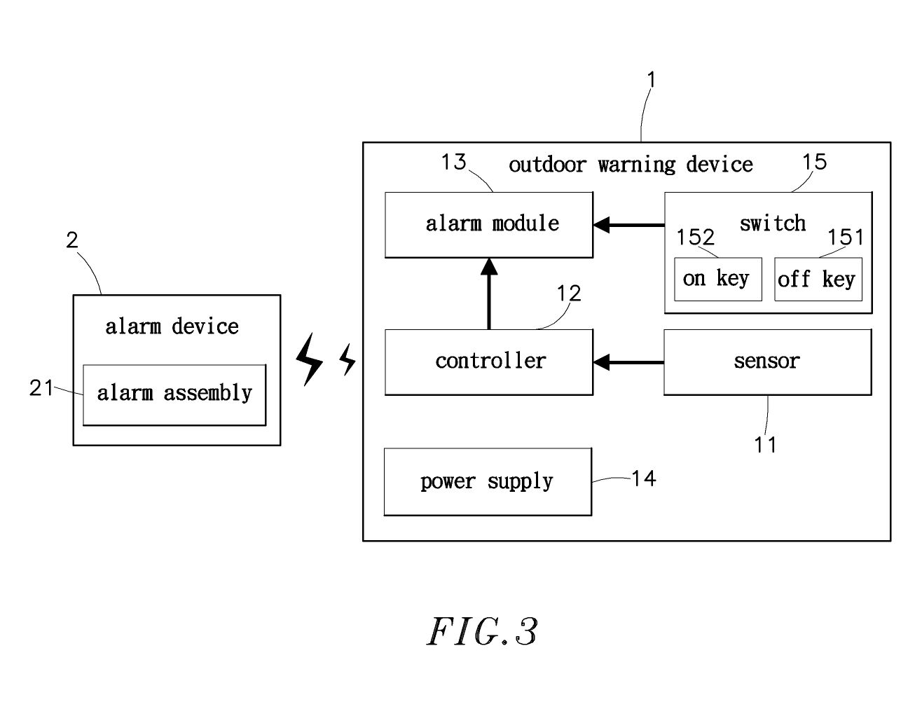

Referring to FIG. 3, an outdoor security device 1 of the present invention, which is similar to that of the embodiment described above, may further comprise a switch 15. The switch 15 comprises an “off” key 151 and an “on” key 152. The “on” key 152 of the switch 15 can control the alarm module 13 for generating bright light or alarm sound or both bright light and alarm sound at the same time. The bright light may be made from a light-emitting diode (LED), a bulb or a warning lamp. The alarm sound may be made form a buzzer or a speaker. When in use, the user can set up the alarm module 13 in a manner to use the bright light or the alarm sound or both the bright light and the alarm sound at the same time for warning. Regardless of the environment, the type of the alarm module 13 can be selected according to the user's need.

Referring to FIG. 3 again, the outdoor warning device 1 can further comprise one or a plurality of alarm device 2 to receive the sensing signal from the controller 12. The alarm device 2 comprises an alarm assembly 21 capable of generating bright light, alarm sound or vibration for warning. The alarm assembly 21 can be light-emitting diodes (LEDs), a bulb or a warning lamp for generating the bright light. The alarm assembly 21 can be a buzzer or a speaker to output the alarm sound. The vibration can be generated from a vibrator to warn the user. When the user carries the alarm device 2 away from the campground and a moving object approaches the outdoor warning device 1, the sensor 11 of the outdoor warning device 1 transmits a sensing signal to the controller 12 and the controller 12 transmits the sensing signal to the alarm device 2 carried by the user, and the alarm assembly 21 of the alarm device 2 further generates the bright light, the alarm sound or the vibration to warn the user.

The alarm module 13 can generate bright light from a light-emitting diode (LED), a bulb or a warning lamp, or employs a buzzer or a speaker to generate alarm sound. The alarm assembly 21 of the alarm device 2 generates bright light by using a light-emitting diode (LED), a bulb or a warning lamp, uses a buzzer or a speaker to generate alarm sound, or uses a vibrator to generate vibration. It should be noted that any equivalent devices capable of generating alarm should be construed to be within the scope of the present invention.

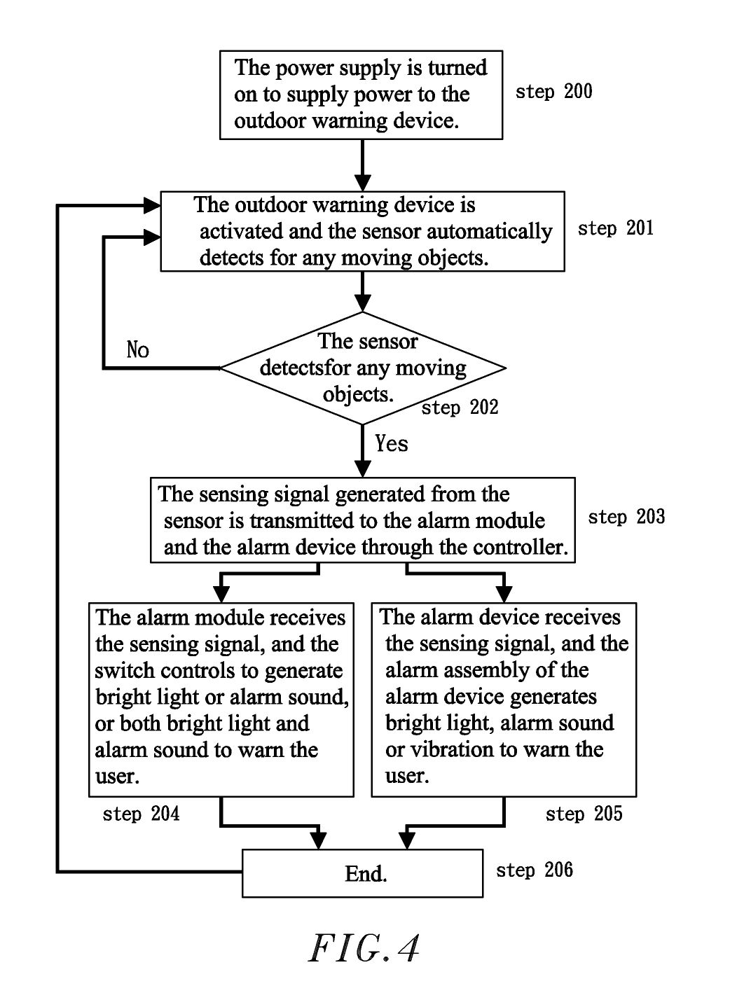

Referring to FIG. 4, a method of detecting moving objects according to another embodiment of the present invention is described hereinafter.

At step 200, the power supply 14 is turned on to supply power to the outdoor warning device 1.

At step 201, the outdoor warning device 1 is activated and the sensor 11 automatically detects for any moving objects.

At step 202, the sensor 11 detects for any moving objects, and if a moving object is detected, a sensing signal is generated; otherwise the process returns to step 201.

At step 203, the sensing signal generated from the sensor 11 is transmitted to the alarm module 13 and the alarm device 2 through the controller 12.

At step 204, the alarm module 13 receives the sensing signal, and through the switch 15 generates bright light or alarm sound, or both bright light and alarm sound to warn the user.

At step 205, the alarm device 2 receives the sensing signal, and the alarm assembly 21 of the alarm device 2 generates bright light, alarm sound or vibration to warn the user.

At step 206, the process ends and returns back to step 201.

The above sensor 11 senses the movement of the objects and generates and transmits a sensing signal to the controller 12. The controller 12 outputs the sensing signal to the alarm module 13 for generating a warning signal to warn the user. It should be noted that any equivalent concept should be construed to be within the scope of the present invention.

Accordingly, the outdoor warning device of the present invention has at least the following advantages.

1. The sensor of the outdoor warning device of the present invention can be a radar sensor, an infrared ray sensor or an ultrasonic sensor. If the sensor is an ultrasonic sensor, the ultrasonic sensor can generate a high-frequency signal wave to keep out the moving objects in order to protect the user.

2. The alarm module of the outdoor warning device of the present invention can generate bright light or alarm sound to warn the user and also signal to the people at a distance for assistance.

3. The outdoor warning device of the present invention has a switch for setting up the alarm module, wherein the user can set up the alarm mode according to the need. For example, using bright light or alarm sound, or both bright light and alarm sound at the same time. Thus, the power consumption can be reduced and the use time of the outdoor warning device may be prolonged.

4. The outdoor warning device of the present invention further comprises an alarm device having an alarm assembly to warn the user by generating bright light, alarm sound or vibration.

While the invention has been described in conjunction with a specific best mode, it is to be understood that many alternatives, modifications and variations will be apparent to those skilled in the art in light of the foregoing description. Accordingly, it is intended to embrace all such alternatives, modifications and variations, which fall within the spirit and scope of the included claims. All matters set forth herein or shown in the accompanying drawings are to be interpreted in an illustrative and non-limiting sense.

What the invention claimed is:

1. An outdoor warning device, comprising:
a sensor, for sensing moving objects and generating a sensing signal accordingly;
a controller, connected to said sensor, for receiving said sensing signal generated from said sensor and outputting said sensing signal;
an alarm module, connected to said controller, for generating alarm to warn a user according to said sensing signal outputted from said controller; and
a power supply, for supplying power to said sensor, said controller and said alarm module.

2. The outdoor warning device according to claim 1, wherein said sensor can be a radar sensor, an infrared ray sensor or an ultrasonic sensor.

3. The outdoor warning device according to claim 1, wherein said outdoor warning device further comprises one or a plurality of alarm devices for receiving said sensing signal from said controller.

4. The outdoor warning device according to claim 3, wherein said alarm device comprises an alarm assembly for generating alarm signals to warn the user.

5. The outdoor warning device according to claim 4, wherein said alarm assembly can be a light-emitting diode (LED), a bulb or a warning lamp for generating bright light.

6. The outdoor warning device according to claim 4, wherein said alarm assembly can be a buzzer or a speaker for generating warning sound.

7. The outdoor warning device according to claim 4, wherein said alarm assembly can be a vibrator for generating vibration.

8. The outdoor warning device according to claim 1, wherein said alarm module can be a light-emitting diode, a bulb or a warning lamp for generating bright light.

9. The outdoor warning device according to claim 1, wherein said alarm assembly can be a buzzer or a speaker for generating warning sound.
